(19) United States
(12) Patent Application Publication
(10) Pub. No.: US 2025/0173555 A1
(43) Pub. Date: May 29, 2025

(54) GENERATIVE AI-BASED STATISTICAL ANALYSIS ASSISTANT

(71) Applicant: Microsoft Technology Licensing, LLC, Redmond, WA (US)

(72) Inventors: Kristina Annika LUUS, Dublin (IE); Pratik MONDKAR, Dublin (IE)

(73) Assignee: Microsoft Technology Licensing, LLC, Redmond, WA (US)

(21) Appl. No.: 18/519,326

(22) Filed: Nov. 27, 2023

(51) Int. Cl. G06N 3/0475; G06F 16/2455; G06F 21/60; G06N 5/04

(52) U.S. Cl. CPC G06N 3/0475; G06F 21/602; G06N 5/04; G06F 16/2455

(57) ABSTRACT

A data processing system implements receiving, via a user interface, a first request for first content to be generated by a generative model, the first request including a first prompt describing the first content associated with output value(s) of a statistical test; executing a query on expert knowledge source(s) to obtain statistical test parameters; constructing, based on a portion of the parameters using a prompt construction unit, prompt(s) to query a user for values associated with the parameters; receiving, via the user interface, response(s) to the prompt(s); retrieving historical data associated with the statistical test; providing the parameter value(s) and the historical data to a calculation tool to generate output value(s); constructing a second prompt as an input to the generative model, by appending at least the prompt(s) and the response(s) with an instruction string comprising instructions to generate an interpretation of the output value(s) as the first content.

### BACKGROUND

Generative models are capable of using artificial intelligence (AI) to generate new data, such as images, text, music, and the like. in response to user prompts. However, generative AI can generate inconsistent, incorrect, or fabricated outputs, called hallucination, that may be caused by insufficient, outdated, or low-quality training data, overfitting, model complexity, stochasticity, bias, and the like. In the context of statistical analysis, such as anomaly detection, statistical tests, and the like, such inconsistent, incorrect, or fabricated generative AI outputs are useless. Taking anomaly detection as an example, the existing incident management systems integrated with calculation tools merely generate formatted anomaly alerts to on-call IT personals, yet the systems cannot perform statistical analysis on demand with satisfactory accuracy and speed. Hence, there is a need for improved systems and methods that provide a technical solution for a user to interact with a generative AI model to generate fast and accurate statistical analysis outputs on demand.

### SUMMARY

An example data processing system according to the disclosure includes a processor and a machine-readable medium storing executable instructions. The instructions when executed cause the processor alone or in combination with other processors to perform operations including receiving, via a user interface of a client device of a user, a first request for first content to be generated by a generative model, the first request including a first prompt describing the first content to be generated, the first content being associated with one or more output values of a statistical test; executing a query on one or more expert knowledge sources to obtain parameters associated with the statistical test, the parameters including one or more input parameters, one or more output parameters, or a combination thereof; constructing, based on at least a portion of the parameters using a prompt construction unit, one or more prompts to query the user for one or more parameter values associated with the parameters; receiving, via the user interface, one or more responses to the one or more prompts, the one or more responses including the one or more parameter values; retrieving historical data including historical parameter values of the parameters, historical data records requested by the user, or a combination thereof associated with the statistical test; providing the one or more parameter values and the historical data to a calculation tool to generate one or more output values associated with the statistical test; constructing a second prompt by the prompt construction unit as an input to the generative model, the prompt construction unit constructing the second prompt by appending at least the one or more prompts and the one or more responses with an instruction string, the instruction string comprising instructions to the generative model to generate an interpretation of the one or more output values as the first content; providing the first content to the client device; and causing the user interface to present the first content.

An example method implemented in a data processing system includes receiving, via a user interface of a client device of a user, a first request for first content to be generated by a generative model, the first request including a first prompt describing the first content to be generated, the first content being associated with one or more output values of a statistical test; executing a query on one or more expert knowledge sources to obtain parameters associated with the statistical test, the parameters including one or more input parameters, one or more output parameters, or a combination thereof; constructing, based on at least a portion of the parameters using a prompt construction unit, one or more prompts to query the user for one or more parameter values associated with the parameters; receiving, via the user interface, one or more responses to the one or more prompts, the one or more responses including the one or more parameter values; retrieving historical data including historical parameter values of the parameters, historical data records requested by the user, or a combination thereof associated with the statistical test; providing the one or more parameter values and the historical data to a calculation tool to generate one or more output values associated with the statistical test; constructing a second prompt by the prompt construction unit as an input to the generative model, the prompt construction unit constructing the second prompt by appending at least the one or more prompts and the one or more responses with an instruction string, the instruction string comprising instructions to the generative model to generate an interpretation of the one or more output values as the first content; providing the first content to the client device; and causing the user interface to present the first content.

An example data processing system according to the disclosure includes a processor and a machine-readable medium storing executable instructions. The instructions when executed cause the processor alone or in combination with other processors to perform operations including receiving, via a user interface of a client device of a user, a first request for first content to be generated by a generative model, the first request including a first prompt describing the first content to be generated, the first content being associated with one or more output values of a statistical test; executing a query on one or more expert knowledge sources to obtain parameters associated with the statistical test, the parameters including one or more input parameters, one or more output parameters, or a combination thereof; constructing, based on at least a portion of the parameters using a prompt construction unit, one or more prompts to query the user for one or more parameter values associated with the parameters; receiving, via the user interface, one or more responses to the one or more prompts, the one or more responses including the one or more parameter values; retrieving historical data including historical parameter values of the parameters, historical data records requested by the user, or a combination thereof associated with the statistical test; providing the one or more parameter values and the historical data to a calculation tool to generate one or more output values associated with the statistical test; constructing a second prompt by the prompt construction unit as an input to the generative model, the prompt construction unit constructing the second prompt by appending at least the one or more prompts and the one or more responses with an instruction string, the instruction string comprising instructions to the generative model to generate an interpretation of the one or more output values as the first content; providing the first content to the client device; and causing the user interface to present the first content.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram of an example computing environment in which the techniques for a user to interact with a generative AI model to generate fast and accurate statistical analysis outputs on demand are implemented.

FIGS. 2A-2B are diagrams of example user interfaces of a statistical analysis assistant application that implements the techniques described herein.

FIG. 3 is a diagram showing additional features of a prompt construction unit of the application services platform shown in FIG. 1.

FIG. 4 is a diagram showing additional features of the prompt construction unit of the application services platform shown in FIG. 1.

FIG. 5 is a flow chart of an example process for a user to interact with a generative AI model to generate fast and accurate statistical analysis outputs on demand according to the techniques disclosed herein.

FIG. 6 is a block diagram showing an example software architecture, various portions of which may be used in conjunction with various hardware architectures herein described, which may implement any of the described features.

FIG. 7 is a block diagram showing components of an example machine configured to read instructions from a machine-readable medium and perform any of the features described herein.

### DETAILED DESCRIPTION

Systems and methods for using generative AI to generate fast and accurate statistical analysis outputs on demand by a user are described herein. These techniques provide a technical solution to the technical problem that statistical analysis outputs generated by generative AI models without calculation capabilities are typically inconsistent, incorrect, or fabricated. The techniques herein automatically identify and obtain expert knowledge, relevant calculation tool(s), and historical data specific for a statistical test of interest. The expert knowledge and relevant calculation tool(s) are sufficient for the generative AI model to interact with the user to set up the statistical test via prompts, in response to an incident alert. The statistical test can involve parameters including input parameters and/or output parameters. For instance, the techniques of a statistical analysis assistant and a chat-based user interaction via a generative model (e.g., GPT4) assist users to set up and execute a statistical analysis test/experiment using expert level guidance, as well as to interpret statistical analysis results of a completed test/experiment. This approach solves the problem of requiring a data scientist to be involved in setting up data analysis tests and to provide test result interpretation. The manual process by a data scientist takes longer time to execute and cannot be scaled. In other words, this approach improves user experience based on an generative model and prompt generation that allows the generative model to suggest how to set up a statistical test and to further parse and interpret the results of the completed test.

As another example, when the user is interested in analyzing incident management data, the system can determine based on expert knowledge that z-core test parameters include sample mean, population mean under the null hypothesis, population standard deviation, and sample size, and then prompt the user to enter one or more of the parameter values for the z-score test. Alternatively, the system can invite the user to accept parameter value(s) assumed or determined by the system. With the parameter values, the system can use the calculation tool specific for the z-score test to calculate other parameter values for setting up the test. During the chat, the user may ask the system to clarify the definition of any of the parameters. As such, the user can set up the test based on the expert knowledge and the calculation tool offered via the system.

In one embodiment, the system can invite the user to import historical data associated with the incident alert, and use the generative model to run the test based on the incident alert and the historical data (e.g., historical incident data), and then parse and interpret the results of the completed test in a summarized and simple manner. For example, the historical data can be provided in an excel file, and the system can interpret inferential statistics of the test results, and determine if the incident alert is normal or not.

The system can invite the user to select one of the common ways/styles/formats to share the experiment results through a communication such as an email, a blog post, and the like. Alternatively, the system can apply the generative model on user data to determine a user-preferred presentation format for the test results, and/or the interpretation/summary of the test results.

In short, the system permits users to benefit from the wealth of internal historical data, documentation and process descriptions so as to rapidly extract relevant insights as if guided by an expert, via a simplified AI chat interface. This approach can be applied in a variety of scenarios, ranging from automated insight provision to business divisions (e.g., Excel®, PowerBI®, and the like.), to situations where IT professionals need insight into potential declines in the health of deployed services to determine whether mitigation is required, and if so, whether mitigation is required immediately or can wait for business hours. For instance, the system can be applied to generate insights every morning for business customers who have received a number of standard reports overnight indicating trends and changes in the business, and the statistical analysis assistant can apply statistical analysis and historical insights from a single document by extracting necessary context, historical data, statistical parameters and correct interpretation based on similar documents.

A technical benefit of the approach provided herein is to save a considerable amount of time and effort for the user to set up and execute a statistical test accurately via a chat-based AI interface without involving a data scientist or IT specialist. Another technical benefit of this approach is to provide accurate and faster tests, as well as easier understanding of the summarized test results in a user-preferred presentation style/format inferred by an AI generative model. Another technical benefit of this approach is to provide output data from the statistical test(s) to a prompt construction unit, which then additionally applies expert knowledge to determine how previous similar incidents have been handled in the past, to generate interpretation/summary of the statistical test(s), and to generate information on relevant code committed to further assist the user to take actions against the incident. Another technical benefit of this approach is to invite users to provide further queries for additional expert knowledge, historical data, and additional statistical anomaly detection tests based on the historical data, such that on-call engineers can quickly and accurately respond to incidents, which helps system owners reduce the costs associated with mitigation of system outages. Another technical benefit of this approach is to use the insights provided to adjust the initial heuristics through which incidents are created. Yet another technical benefit of this approach is to use the test result data as training data in a feedback loop, to not only improve the output of the generative model, but also decrease the computing resources required in the future. These and other technical benefits of the techniques disclosed herein will be evident from the discussion of the example implementations that follow.

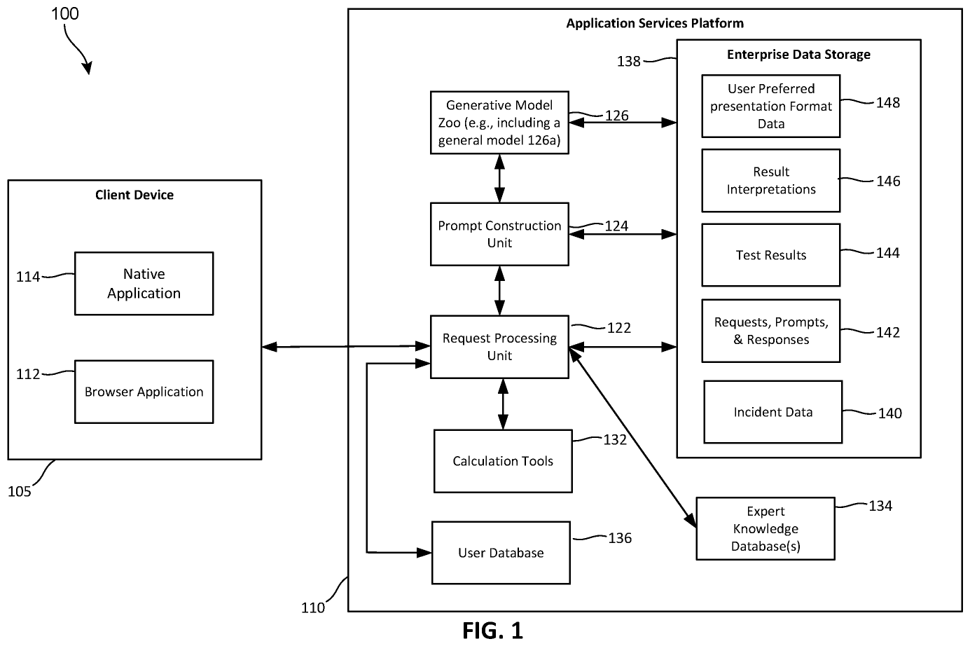

FIG. 1 is a diagram of an example computing environment 100 in which the techniques herein may be implemented. The example computing environment 100 includes a client device 105 and an application services platform 110. The application services platform 110 provides one or more cloud-based applications and/or provides services to support one or more web-enabled native applications on the client device 105. These applications may include but are not limited to statistical analysis assistant applications, presentation applications, web site authoring applications, collaboration platforms, communications platforms, and/or other types of applications in which users may create, view, and/or modify various types of statistical tests. In the implementation shown in FIG. 1, the application services platform 110 also applies generative AI to generate fast and accurate statistical analysis outputs upon user demand without involving a data scientist or IT specialist according to the techniques described herein. The client device 105 and the application services platform 110 communicate with each other over a network (not shown). The network may be a combination of one or more public and/or private networks and may be implemented at least in part by the Internet.

The client device 105 is a computing device that may be implemented as a portable electronic device, such as a mobile phone, a tablet computer, a laptop computer, a portable digital assistant device, a portable game console, and/or other such devices in some implementations. The client device 105 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 1 includes a single client device 105, other implementations may include a different number of client devices that utilize services provided by the application services platform 110.

As used herein, the term “a statistical test” refers refer to a procedure or method used to statistically analyze data, which may involve various statistical techniques, algorithms, or software tools. In data analysis, there are numerous types of tests and procedures used to gain insights from data, such as hypothesis testing, descriptive statistics, regression analysis, cluster analysis, time series analysis, data visualization, data mining, statistically significant tests, and the like., depending on the research or analytical objectives. Although various embodiments are described with respect to incident management, it is contemplated that the approach described herein may be used with other statistical tests in financial, business and marketing, manufacturing and quality control, transportation and logistics, environmental, healthcare, social sciences, government and public policy, and other fields.

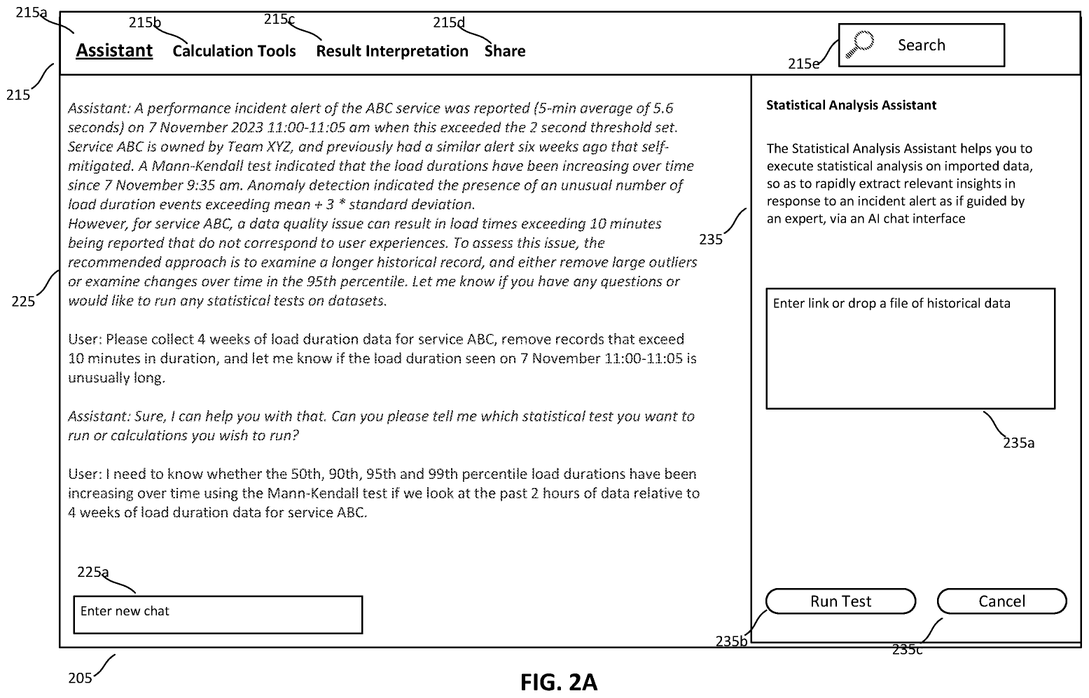

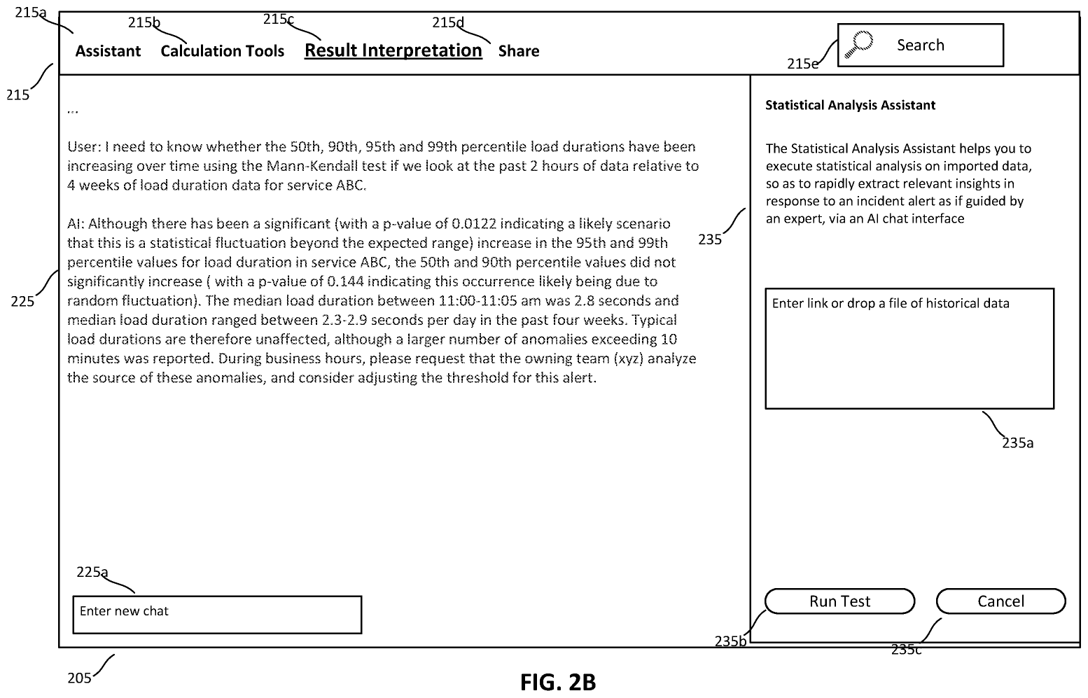

The client device 105 includes a native application 114 and a browser application 112. The native application 114 is a web-enabled native application, in some implementations, which enables users to view, create, and/or modify statistical tests. The web-enabled native application utilizes services provided by the application services platform 110 including but not limited to creating, viewing, and/or modifying various types of statistical tests and obtaining expert knowledge and/or calculation tool(s) for creating and/or modifying the statistical tests. The native application 114 implements a user interface 205 shown in FIGS. 2A-2B in some implementations. In other implementations, the browser application 112 is used for accessing and viewing web-based content provided by the application services platform 110. In such implementations, the application services platform 110 implements one or more web applications, such as the browser application 112, that enables users to view, create, and/or modify statistical tests and to obtain expert knowledge and/or calculation tool(s) recommendations for creating and/or modifying the statistical tests. The browser application 112 implements the user interface 205 shown in FIGS. 2A-2B in some implementations. The application services platform 110 supports both the native application 114 and the browser application 112 in some implementations, and the users may choose which approach best suits their needs.

The application services platform 110 includes a request processing unit 122, a prompt construction unit 124, a generative model zoo 126, calculation tools 132, expert knowledge database(s) 134, and the user database 136, and moderation services.

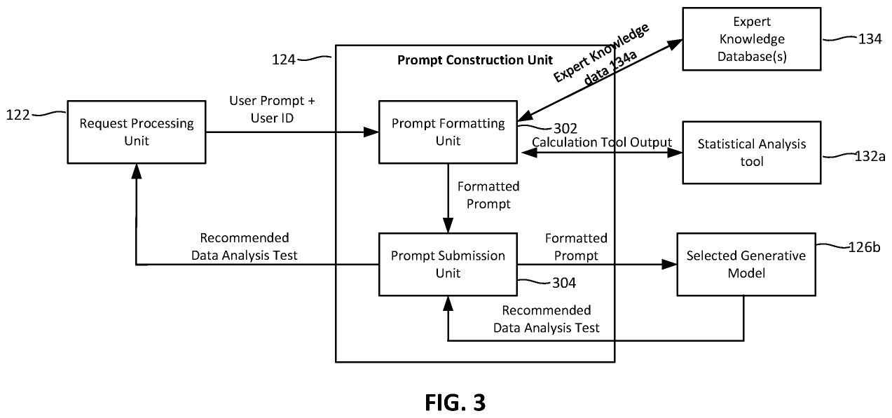

The request processing unit 122 is configured to receive requests from the native application 114 and/or the browser application 112 of the client device 105. The requests may include but are not limited to requests to create, view, and/or modify various types of statistical tests and/or sending natural language prompts to a selected generative model 126b (explained in detail later in FIG. 3) to set up a statistical test and interpret test results later according to the techniques provided herein. The selected generative model 126b can be selected from the generative model zoo 126 for the statistical test considering the specific field of research, the availability of pre-trained models, and the like. The request processing unit 122 also coordinates communication and exchange of data among components of the application services platform 110 as discussed in the examples which follow.

In one embodiment, the selected generative model 126b is a generative AL model trained to generate content (e.g., textual, spreadsheet, chart, report, audio, image, video, and the like.) in response to natural language prompts input by a user via the native application 114 or via the web. The selected generative model 126b is implemented using a large language model (LLM) in some implementations. Examples of such models include but are not limited to a Generative Pre-trained Transformer 3 (GPT-3), or GPT-4 model. Other implementations may utilize other models or other generative models to set up a statistical test according to the presentation style/format of the user.

The request processing unit 122 receives a user request to set up and execute a statistical test from the native application 114 or the browser application 112. For example, the user request is a natural language prompt input by the user as is then passed on to the prompt construction unit 124. The natural language prompt requests to set up and execute a statistical test and identify the user submitting the natural language prompt. The natural language prompt may imply or indicate that the user would like to have the statistical test set up and executed by a generative model (e.g., a general generative model 126a in a generative model zoo 126). For example, the user request is expressed in a user prompt: “help me set up a statistical test,” or “I want to use ChatGPT to set up a statistical test.”

Once the general generative model 126a tokenizes and interprets the user prompt for setting up and executing the particular statistical test, either the general generative model 126a or the prompt construction unit 124 can preformulate meta-prompts for querying the user based on external expert knowledge.

The prompt construction unit 124 can access expert knowledge source(s) including expert knowledge database(s) 134 based on the statistical test. The relevant expert knowledge includes a description of the statistical test. For instance, the relevant expert knowledge specifies a subject matter of the statistical test to be set up, definitions of parameter(s) of the statistical test, and/or parameter value(s) of the parameter(s). The parameters can include input parameter(s) and/or output parameters such as but not limited to parameter(s) and/or output parameters extracted by the general generative model 126a from the expert knowledge database(s) 134. The relevant expert knowledge can also specify target result(s) of the statistical test to be generated. The parameter value(s) can be provided by the user via prompt interaction, extracted as rule-of-thumb values or heuristics from the relevant expert knowledge, and/or generated via the general generative model 126a. For instance, the user can specify various types of parameter value(s) of the statistical test to be deployed as shown in FIG. 2A.

In one embodiment, the prompt construction unit 124 obtains information associated with the statistical test from the expert knowledge database(s) 134. Such information or expert knowledge can include parameters/metrics definitions, technical specifications, how to analyze calculation tool output(s), and the like.

The prompt construction unit 124 then uses parameters/metrics associated with the statistical test obtained from the expert knowledge database(s) 134 to generate meta-prompts for parameter values. The prompt construction unit 124 parses and filters the parameter metrics provided to extract relevant definitions and possible values of the parameters and to generate prompts in a format that can be included in the prompt to the selected generative model 126b. Additional details of a selected calculation tool, e.g., a statistical analysis tool 132a are shown in FIG. 3, which is described in detail in the examples which follow.

The expert knowledge source(s) can be online/offline databases, documents, articles, books, presentation content, and/or other types of content containing knowledge possessed by experts in a particular domain. Such expert knowledge data 134a can be digitized and stored in the expert knowledge database(s) 134.

When the expert knowledge is contained in documents, the system can apply document summarization techniques on the documents and then parse natural language and use SQL-type queries to retrieve data into a templatized format. Then, the system can guide statistical analysis using expert knowledge contained in the documentation, and infer the meaning of values contained in spreadsheets according to the templatized format. For instance, the system can infer how different metrics in a scorecard relate to the experiment specifications outlined in another document.

Generative models, such as the selected generative model 126b, can experience hallucinations in which the generated content, especially numerical values, is nonsensical or inaccurate for the statistical test. The generative model may experience intrinsic or extrinsic hallucinations. Intrinsic hallucinations contradict the source content, and extrinsic hallucinations cannot be verified or contradicted by the source content. Examples of such intrinsic hallucinations may include but are not limited to the parameter values being simply outside of the defined range, or the selected generative model 126b outputting inconsistent values for the same parameter. To address model hallucinations, the prompt construction unit 124 can select, based on the expert knowledge data 134a, the statistical analysis tool 132a among the calculation tools 132 for calculating the remaining parameter value(s) for the statistical test supplemental to the parameter value(s) extracted from user prompts in response to the meta-prompts and/or rule-of-thumb parameter values assumed by the prompt construction unit 124. The prompt construction unit 124 can select a preferred calculation tool (e.g., the statistical analysis tool 132a) from the calculation tools 132 for the statistical test considering the nature of the data analysis, the specific calculations required, and the like.

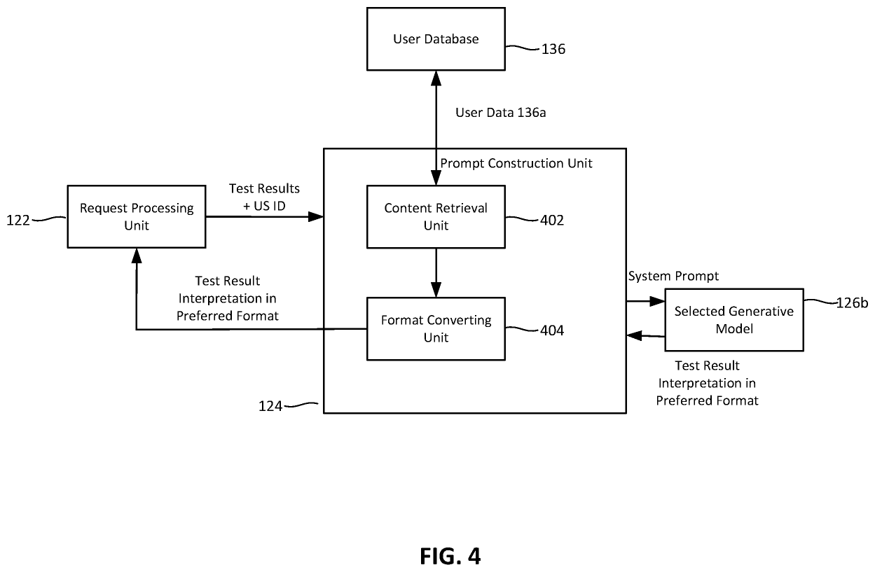

Additional details of the prompt construction unit 124 are shown in FIGS. 3-4, which is discussed in detail in the examples which follow. The prompt construction unit 124 may reformat or otherwise standardize the information to be included in the prompt to a standardized format that is recognized by the selected generative model 126b. The selected generative model 126b is trained using training data in this standardized format, in some implementations, and utilizing this format for the prompts provided to the selected generative model 126b may improve the predictions provided by the selected generative model 126b. In another embodiment, the prompt construction unit 124 can determine based on the expert knowledge data 134a that there are other models better fitting the statistical test, and update the generative model accordingly.

The prompt construction unit 124 processes the calculation tool output into a format directly processible by the selected generative model 126b. For instance, the calculation tool output can be converted into high-dimensional vector(s), i.e., mathematical representation(s) of data. As another instance, the calculation tool output is converted into a portion of a graph that stores relationships between value token(s) in a sequence. As another instance, the calculation tool output is converted into a token with an embedding matrix having dimensions representing different features of the token.

When the expert knowledge data 134a from the expert knowledge database(s) 134 is already in the format directly processible by the selected generative model 126b, the prompt construction unit 124 does not need to convert the expert knowledge data 134a. When the expert knowledge data 134a is not in the format directly processible by the selected generative model 126b, the prompt construction unit 124 converts the expert knowledge data 134a to the format directly processible by the selected generative model 126b.

The prompt construction unit 124 then constructs a system prompt based the user-input parameter values, system-assumed parameter values, the formatted calculation tool output, as well as the formatted expert knowledge, and then outputs the system prompt to execute the statistical test based on the historical data.

In the following scenario, the system is deployed on an incident management portal that contains information about a specific incident that has generated an alert, and the system can access information contained on an alert page. Typically, such alerts are generated when manually-specified thresholds are breached, resulting in an email and phone call to relevant on-call engineers, who then triage incidents according to their severity. The incident-specific information is typically completed manually, and there often is not enough information to easily determine the actual severity, especially for users unfamiliar with the monitored system causing an alert.

In the initial incident-triggered stage, the system can collect information relevant to the specific incident (e.g., ticket ID, date, time, threshold breached, variable of interest, and the like.), and then apply the relevant information to query a historical data record. For example, the system can read from the alert “Incident 295820 identifies a degradation in performance of service ABC on 7 Nov. 2023 11:00-11:05 am (5.6 seconds)”, the following incident facts: the ticket ID as 295820, the time as “7 Nov. 2023 11:00-11:05 am”, the threshold breached as “Performance degradation to 5.6 seconds exceeds 2 second threshold set”, and the variable of interest as “Performance.”

The system can then query historical data to retrieve a record for any variable of interest, such as the variable raising the alert (e.g., daily average performance data of “Performance” as shown in Table 1), or a variable requested by the user, and the like.

TABLE 1

| | Day | | | | | | | |
|---|---|---|---|---|---|---|---|---|
| | 1 | 2 | 3 | 4 | 5 | 6 | 7 | 8 |
| Avg | 0.8 | 1.1 | 0.9 | 1.0 | 0.8 | 0.9 | 1.1 | 1.0 |
| Performance | | | | | | | | |

In some implementations, the system can apply one or more statistical tests to the historical records using a relevant calculation tool (e.g., a statistical analysis tool). The statistical tests can include Z-score test, Mann-Kendall test, T-test, standard deviation, one-class support vector machines (SVM), autoregressive integrated moving average (ARIMA), and the like. The system then provides the statistical analysis output data to the prompt construction unit 124.

For example, first, the prompt construction unit 124 generates the meta-prompt in Table 2, and then appends that to the beginning of a system prompt.

TABLE 2
As a Statistical Analysis Assistant, your role is to act as an incident response system to help
users to determine the severity, veracity, and root causes of incidents that are reported within
this system. Please make use of the expert guidance below to inform the analysis you provide
of relevant historical datasets. These include information about the statistical tests
performed, and how to correctly assess the incidents reported.

Second, the prompt construction unit 124 includes the relevant incident facts (e.g., the ticket ID as 295820, the time as “7 Nov. 2023 11:00-11:05 am”, the threshold breached as “Performance degradation to 5.6 seconds exceeds 2 second threshold set”, and the variable of interest as “Performance”) in the system prompt. Third, the prompt construction unit 124 extracts the relevant expert knowledge data 134a from the expert knowledge database(s) 134, and then appends the paragraph in Table 3 into the system prompt. Forth, the prompt construction unit 124 enters the system prompt into the selected generative model 126b.

TABLE 3
Performance refers to the load duration (in seconds) for the specified service. The average
load duration is 1.2 seconds, and durations over 10 seconds are encountered in less than
0.01% of cases. However, anomalies on the order of weeks can be occasionally encountered
when users close their laptops while the application is loading, and reopen them much later.
Although these cause an increase in mean load duration, represented as degradation in
performance, these anomalies are typically harmless. Detect anomalies in performance
through time-series analysis, and by examining performance of the 99th percentile rather
than mean load durations.

Fifth, the prompt construction unit 124 appends statistical test results output by the selected generative model 126b to additional information on how to interpret the statistical test results into another system prompt. Sixth, the prompt construction unit 124 appends a closing meta-prompt in Table 4 to the end of the other system prompt.

TABLE 4
Provide a summary to the user of the incident detected. Analyze the results from statistical
tests using the guidance provided, and describe the anomaly detected according to historical
data. Ask if the user has any questions, and await reply.

Seventh, the prompt construction unit 124 enters the other system prompt into the selected generative model 126b to provide a curated incident, set within the business context, such as the first Assistant prompt in FIG. 2A. The request(s), prompts and responses generated during the initial incident-triggered stage are stored in the enterprise storage 138 for future use.

In a subsequent user-query-triggered stage, the prompt construction unit 124 combines information from different sources to create a system prompt to be sent to the selected generative model 126b. First, the prompt construction unit 124 appends text from a meta-prompt in Table 5 at the beginning of the system prompt.

TABLE 5
As a Statistical Analysis Assistant, your role is to act as an incident response system to help
users to determine the severity, veracity, and root causes of incidents that are reported within
this system. Please make use of the expert guidance below to inform the analysis you provide
of relevant historical datasets. These include information about the statistical tests
performed, and how to correctly assess the incidents reported

Second, the prompt construction unit 124 reads in all previous requests, prompts, responses, statistical tests, and statistical test results generated during the initial incident-triggered stage. Third, the prompt construction unit 124 gets name(s) of additional statistical test(s) to perform from the user with a prompt: “Can you run a Z-score test for last 4 weeks of data excluding load duration over 10 minutes?” Fourth, the prompt construction unit 124 gets parameters for additional test(s) from the user with a prompt: “what is the significance threshold of the test?” Fifth, the prompt construction unit 124 requests for additional historical data as requested by the user and the test(s) to be performed by the calculation tool. Sixth, the prompt construction unit 124 receives and appends the calculation tool output data in Table 6 to the prompt.

TABLE 6
The Z-test returned with a p-value of 0.0245 for the given data over the last weeks below
the specified threshold of 0.05

Seventh, the prompt construction unit 124 adds a closing meta-prompt in Table 7 to the end of the other system prompt, and then enters the other system prompt into the selected generative model 126b to provide a response of interest, such as the last Assistant prompt in FIG. 2B.

TABLE 7
Provide a summary of the results from statistical tests using the guidance provided, and
describe the anomaly detected according to historical data. Ask if the user has any questions,
and await reply

By analogy, if the user can ask additional questions, the prompt construction unit 124 can repeat the user-query-triggered stage for any subsequent questions. Various statistical tests can then be applied to the historical data record on demand to reveal whether the incident associated with the alert is anomalous or within expected bounds. The output data from the statistical test(s) is then provided to a prompt construction unit, which then additionally applies expert knowledge to determine how previous similar incidents have been handled in the past, to generate interpretation/summary of the statistical test(s), and to generate information on relevant code committed to further assist the user to take actions against the incident.

Users are then invited to provide further queries for additional expert knowledge, historical data, and additional statistical anomaly detection tests based on the historical data. As such, on-call engineers are able to quickly and accurately respond to incidents, which saves system owners a great deal in costs associated with mitigation of system outages. Additionally, the insights provided can be used to adjust the initial heuristics through which incidents are created.

In some implementations, the selected generative model 126b can present or share the test result interpretation in a default or user-preferred style/format. In one embodiment, the user inputs a prompt in the chat with the selected generative model 126b to analyze and present the test results. For instance, the user prompt can be “write me a blog post on the results of the statistical test for which the data is provided in the attached excel file.”

In one embodiment, in response to the test result prompt, either the prompt construction unit 124 or the selected generative model 126b can retrieve user data from a user database 136 based on an indication identifying the user in the test result prompt. The indication may be a user identifier (e.g., a username, email address, and the like.), and/or other identifier associated with the user that the application services platform 110 can use to identify the user. The user data can include a user role (e.g., a product manager), a user organization, a user division in the organization, a user preferred presentation style (e.g., non-technical descriptive), a specified file format (e.g., Microsoft OPG Commons articles), whether to send an email copy of the presentation output, and the like. The test result output can be adjusted to match any user preferences, such as project specifications for product managers, development design documents for engineers, and the like.

When the user data 136a from the user database 136 is already in the format directly processible for the selected generative model 126b, the prompt construction unit 124 or the selected generative model 126b does not need to process expert knowledge. When the user data 136a is not in the format directly processible for the selected generative model 126b, the prompt construction unit 124 or the selected generative model 126b can process the user data 136a to the format directly processible for the selected generative model 126b.

The prompt construction unit 124 can retrieve the expert knowledge data 134a and/or summaries of the expert knowledge data 134a, like metrics definitions, technical specifications, and how to analyze test results, then generate a system prompt based on the expert knowledge data/summaries and the user profile data, to request the selected generative model 126b to generate a desired presentation output. For instance, the test result system prompt can append the user test result prompt to the user test recommendation prompt and/or previous responses. The selected generative model 126b then generates a response that includes a blog post of the statistical test results to be present on the client device 105.

The formatted expert knowledge/summaries and corresponding user preferred presentation descriptions (e.g., for a variety of document types) can be permanently incorporated in the selected generative model 126b for future use.

All the above-discussed incident data 140, request prompts and responses 142, test results 144, result interpretations 146, and user preferred presentation format data 148 can be stored in an enterprise data storage 138. The enterprise data storage 138 can be physical and/or virtual, depending on the entity's needs and IT infrastructure. Examples of physical enterprise data storage systems include network-attached storage (NAS), storage area network (SAN), direct-attached storage (DAS), tape libraries, hybrid storage arrays, object storage, and the like. Examples of virtual enterprise data storage systems include virtual SAN (vSAN), software-defined storage (SDS), cloud storage, hyper-converged Infrastructure (HCl), network virtualization and software-defined networking (SDN), container storage, and the like.

There are security and privacy considerations and strategies for using open source generative models with enterprise data, such as data anonymization, isolate data, secure access, secure the model, use a secure environment, encryption, regular auditing, compliance with laws and regulations, data retention policies, privacy impact assessment, user education, regular updates, disaster recovery and backup, incident response plan, third-party reviews, and the like. By following these security and privacy best practices, the example computing environment 100 can minimize the risks associated with using open source generative models while protecting enterprise data from unauthorized access or exposure.

For instance, the application services platform 110 can store enterprise data separately from generative model training data, to reduce the risk of unintentionally leaking sensitive information during model generation. The application services platform 110 can limit access to generative models and the enterprise data. The application services platform 110 can implement proper access controls, strong authentication, and authorization mechanisms to ensure that only authorized personnel can interact with the selected model and the enterprise data.

The application services platform 110 can also run the generative model in a secure computing environment. The application services platform 110 can employ robust network security, firewalls, and intrusion detection systems to protect against external threats. The application services platform 110 can encrypt the enterprise data and any data in transit. The application services platform 110 can employ encryption standards for data storage and data transmission to safeguard against data breaches.

The application services platform 110 can implement strong security measures around the selected generative model itself, such as regular security audits, code reviews, and ensuring that the model is up-to-date with security patches. The application services platform 110 can periodically audit the generative model's usage and access logs, to detect any unauthorized or anomalous activities. The application services platform 110 can also ensure that any use of open source generative models complies with relevant data protection regulations such as GDPR, HIPAA, or other industry-specific compliance standards.

The application services platform 110 can establish data retention and data deletion policies to ensure that generated data is not stored longer than necessary, to minimizes the risk of data exposure. The application services platform 110 can perform a privacy impact assessment (PIA) to identify and mitigate potential privacy risks associated with the generative model's usage. The application services platform 110 can train and educate users on the proper handling of enterprise data and the responsible use of generative models. In addition, the application services platform 110 can stay up-to-date with evolving security threats and best practices is essential for ongoing data protection.

FIGS. 2A-2B are diagrams of an example user interface of a statistical analysis assistant application that implements the techniques described herein. The example user interface shown in FIGS. 2A-2B is a user interface of a statistical analysis assistant application, such as but not limited to Microsoft Copilot®. However, the techniques herein for a user to interact with a generative AI model to generate fast and accurate statistical analysis outputs on demand are not limited to use in the statistical analysis assistant application and may be used to generate content for other types of applications including but not limited to presentation applications, web site authoring applications, collaboration platforms, communications platforms, and/or other types of applications in which users create, view, and/or modify various types of statistical tests. Such applications can be a stand-alone application, or a plug-in of any application on the client device 105, such as the browser application 112, the native application 114, and the like.

FIG. 2A shows an example of the user interface 205 of a statistical analysis assistant application in which the user is interacting with an AI generative model to run a statistical test. The user interface 205 includes a control pane 215, a chat pane 225 and a statistical analysis assistant pane 235. The user interface 205 may be implemented by the native application 114 and/or the browser application 112.

In some implementations, the control pane 215 includes an Assistant tab 215a, a Calculation Tools tab 215b, a Result Interpretation tab 215c, and a Share tab 215d. The Assistant tab 215a can be selected to provide statistical analysis assistant functions as later discussed in conjunction with FIG. 2A. The Calculation Tools tab 215b can be selected to trigger a dropdown list of available calculation tools, or to display an option for the user to request the statistical analysis assistant application to recommend a calculation tool, or to display a field for the user to enter a name of a calculation tool. The fields in the statistical analysis assistant application can provide auto-fill and/or spell-check functions. The Result Interpretation tab 215c can be selected to generate and present test result interpretation as output by the selected generative model 126b as later discussed in conjunction with FIG. 2B. The Share tab 215d can be selected to trigger a dropdown list of applications (e.g., email, calendar, social media, blog, and the like.) to share prompt history, test result data, test result interpretation, and the like. In addition, the control pane 215 includes a Search field 215e for a user to enter a search word, phrase, paragraph, and the like. within the prompt history, the test result data, the test result interpretation, and the like.

In some implementations, the chat pane 225 provides a workspace in which the user can enter prompts in the statistical analysis assistant application. The chat pane 225 also includes a new prompt enter box 225a enabling the user to enter a natural language prompt. In the example shown in FIG. 2A, the chat pane 225 has two Assistant prompts and two user prompts to set up a statistical test. The first Assistant prompt was generated by the selected generative model 126b as triggered based on a breach of a previously-set incident alert threshold: “Performance degradation to 5.6 seconds exceeds 2 second threshold set.”

The first Assistant prompt includes a summary of an incident alert within the relevant business context, and additional statistical analyses conducted based on the historical data relating to incident record(s). In this example, the incident alert was about “Incident 295820 identifies a degradation in performance of service ABC on 7 Nov. 2023 11:00-11:05 am (5.6 seconds)”. The relevant business context includes “Service ABC is owned by Team XYZ, and previously had a similar alert six weeks ago that self-mitigated.” The additional statistical analyses conducted based on the historical data includes “A Mann-Kendall test indicated that the load durations have been increasing over time since 7 November 9:35 am. Anomaly detection indicated the presence of an unusual number of load duration events exceeding mean+3*standard deviation. However, for service ABC, a data quality issue can result in load times exceeding 10 minutes being reported that do not correspond to user experiences. To assess this issue, the recommended approach is to examine a longer historical record, and either remove large outliers or examine changes over time in the 95th percentile.”

The user prompts describe content that the user would like to have automatically generated by the selected generative model 126b of the application services platform 110. The application submits the natural language prompt to the application services platform 110 and user information identifying the user of the application to the application services platform 110. The application services platform 110 processes the request according to the techniques provided herein to set up a statistical test according to the parameter value(s) in the user prompt.

In this example, the first user prompt requests the application to collect 4 weeks of load duration data for service ABC, remove records that exceed 10 minutes in duration, and to determine if the load duration seen on 7 November 11:00-11:05 am is unusually long.

The second Assistant prompt replies: “Sure, I can help you with that. Can you please tell me which statistical test you want to run or calculations you wish to run?” The second user prompt replies: “I need to know whether the 50th, 90th, 95th and 99th percentile load durations have been increasing over time using the Mann-Kendall test if we look at the past 2 hours of data relative to 4 weeks of load duration data for service ABC.”

In some implementations, the data analysis assistant pane 235 is automatically presented on the user interface 205 when the user requests to set up a new statistical test, and/or accessing a statistical file in the statistical analysis assistant application. Alternatively, the data analysis assistant pane 235 may be displayed in response to a user input, such as a keystroke combination or in response to the user activating a menu item or other user interface element on the user interface 205. The data analysis assistant pane 235 automatically displays a function summary: “The Statistical Analysis Assistant helps you to execute statistical analysis on imported data, so as to rapidly extract relevant insights in response to an incident alert as if guided by an expert, via an AI chat interface.”

The data analysis assistant pane 235 includes a data import box 235a that enables the user to enter a uniform resource locator (URL), or drop a file of historical data, e.g., 4 weeks of load duration data for service ABC. The data analysis assistant pane 235 also includes a “Run Test” button 235b and a “Cancel” button 235c. Once the historical data is imported, the application services platform 110 can automatically run the test, or run the test in response to an activation of the Run Test button 235b. In one embodiment, the application services platform 110 can generate a prompt to send to the selected generative model 126b to set up and execute a statistical test (e.g., the Mann-Kendall test) according to the user requests/prompts according to the techniques provided herein. The application services platform 110 will stop the test in response to an activation of the “Cancel” button 235c.

FIG. 2B shows an example of the user interface 205 in which an interpretation of the statistical test results is presented in the chat pane 225, either automatically or in repose to an activation of the Result Interpretation tab 215c. In this example, the result interpretation states: “Although there has been a significant (with p-value of 0.0122 indicating a likely scenario that this is a statistical fluctuation beyond the expected range) increase in the 95th and 99th percentile values for load duration in service ABC, the 50th and 90th percentile values did not significantly increase (with a p-value of 0.144 indicating this occurrence likely being due to random fluctuation). The median load duration between 11:00-11:05 am was 2.8 seconds and median load duration ranged between 2.3-2.9 seconds per day in the past four weeks. Typical load durations are therefore unaffected, although a larger number of anomalies exceeding 10 minutes was reported.”

In some implementations, the result interpretation can be presented with an action suggestion to mitigate the incident alert, such as: “During business hours, please request that the owning team (xyz) analyze the source of these anomalies, and consider adjusting the threshold for this alert.”

The user prompts and the user information has been submitted to the application services platform 110, and the test result data generated by the selected generative model 126b according to the presentation style/format of the user is presented in the chat pane 225 of the user interface 205. In some implementations, the user may submit further prompts requesting additional content to be generated and/or to further refine the content that has already been generated. The request processing unit 122 stores the content items included in prompt in some implementations for the duration of the user session in which the user uses the native application 114 or the browser application 112. A technical benefit of this approach is that the sample content items do not need to be retrieved each time that the user submits a natural language prompt to generate content. The request processing unit 122 maintains user session information in a persistent memory of the application services platform 110 and retrieves the sample content items from the user session information in response to each subsequent natural language prompt submitted by the user. The request processing unit 122 then provides the newly received natural language prompt and the sample content items to the prompt construction unit 124 to construct the prompt as discussed in the preceding examples.

FIG. 3 is a diagram showing additional features of the prompt construction unit 124 of the application services platform shown in FIG. 1. The prompt construction unit formats and submits the prompt for the selected generative model 126b. The prompt construction unit 124 includes a prompt formatting unit 302 and a prompt submission unit 304.

The prompt formatting unit 302 receives a natural language prompt input by the user and the sample content items output by the selected calculation tool 132a. The prompt formatting unit 302 formats the prompt according to a prompt template and includes the natural language prompt and at least a portion of parameters/metrics of the statistical test in the content of the prompt. The prompt template includes instructions that guide the selected generative model 126b to set up and execute the statistical test. The example prompts in FIGS. 2A-2B can instruct the selected generative model 126b to generate a single-shot prompt or a multi-shot prompt to query the user for known parameter values. Other implementations may include instructions in addition to and/or instead of one or more of these instructions. Furthermore, the specific format of the prompt may differ in other implementations.

In one embodiment, the prompt formatting unit 302 is configured to select a predetermined number of test results to be included in the system prompt to be sent to the selected generative model 126b. If the number of test result items is less that a predetermined number, then the prompt formatting unit 302 includes all of the test result items. The number of test result items selected may be determined at least in part on the prompt size limits of the selected generative model 126b. Language models typically have a limit on the number of tokens that can be included in the prompt, which will limit the number of test result items and other items to be included in the prompt. The selected test result items can be formatted into a format directly processible by the selected generative model 126b.

In some implementations, the prompt formatting unit 302 selects from among multiple prompt templates. In such implementations, the prompt formatting unit 302 analyzes the natural language prompt using a second language model trained to analyze a textual input and to classify the subject matter of the textual input into one of a predetermined set of categories. Each category is associated with a respective prompt template. The prompt submission unit 304 submits the natural language prompt to the second language model to obtain a predicted category and then selects the appropriate prompt template to be used to construct the prompt.

The prompt submission unit 304 submits the formatted prompt to the moderation services to ensure that the prompt does not include any potentially objectionable or offensive content. The prompt formatting unit 302 halts the processing of the prompt in response to the moderation services determining that the prompt includes potentially objectionable or offensive content. As discussed in the preceding examples, the moderation services generates a blocked content notification in response to determining that the prompt includes potentially objectionable or offensive content, and the notification is provided to the native application 114 or the browser application 112 so that the notification can be presented to the user on the client device 105. The user may attempt to revise and resubmit the natural language prompt.

The prompt submission unit 304 submits the formatted prompt to the selected generative model 126b. The selected generative model 126b analyzes the prompt and generates a response based on the prompt. The prompt submission unit 304 submits the response generated by the language model to the moderation services to ensure that the response does not include any potentially objectionable or offensive content. The prompt formatting unit 302 halts the processing of the response in response to the moderation services determining that the prompt includes potentially objectionable or offensive content. The moderation services generates a blocked content notification in response to determining that the generated content includes potentially objectionable or offensive content, and the notification is provided to the native application 114 or the browser application 112 so that the notification can be presented to the user on the client device 105. The user may attempt to revise and resubmit the natural language prompt. If the moderation services does not identify any issues with the generated content output by the selected generative model 126b in response to the prompt, the prompt submission unit 304 provides the generated output to the request processing unit 122. The request processing unit 122 the provides the generated content to the native application 114 or the browser application 112 depending upon which application was the source of the request to generate content.

In one embodiment, the application services platform 110 includes a moderation services that analyze user prompt(s), content generated by the selected generative model 126b, the expert knowledge data 134a obtained from the expert knowledge database(s) 134, and/or the calculation tool output to ensure that potentially objectionable or offensive content is not generated or utilized by the application services platform 110. If potentially objectionable or offensive content is detected, the moderation services provides a blocked content notification to the client device 105 indicating that the prompt(s), the content generated by the selected generative model 126b, the expert knowledge data 134a, and/or the calculation tool output is blocked.

In some implementations, the statistical analysis tool 132a discards any content that includes potentially objectionable or offensive content and passes any remaining content that has not been discarded to the request processing unit 122 to be provided as an input to the prompt construction unit 124. In other implementations, the prompt construction unit 124 discards any content that includes potentially objectionable or offensive content and passes any remaining content that has not been discarded to the selected generative model 126b as an input.

The moderation services performs several types of checks on the statistical tests item being accessed or modified by the user in the native application 114 or the browser application 112, the natural language prompt input by the user, the sample content obtained from the expert knowledge database(s) 134, and/or content generated by the selected generative model 126b. The moderation services can be implemented by a machine learning model trained to analyze the content of these various inputs to perform a semantic analysis on the content to predict whether the content includes potentially objectionable or offensive content. The moderation services can perform another check on the content using a second model configured to analyze the words and/or phrase used in content to identify potentially offensive language/image/sound. The moderation services can compare the language used in the content with a list of prohibited terms/images/sounds including known offensive words and/or phrases, images, sounds, and the like. The moderation services can provide a dynamic list that can be quickly updated by administrators to add additional prohibited terms/images/sounds. The dynamic list may be updated to address problems such as words or phrases becoming offensive that were not previously deemed to be offensive. The words and/or phrases added to the dynamic list may be periodically migrated to the guard list as the guard list is updated. The specific checks performed by the moderation services may vary from implementation to implementation. If one or more of these checks determines that the textual content includes offensive content, the moderation services can notify the application services platform 110 that some action should be taken.

In some implementations, the moderation services generates a blocked content notification, which is provided to the client device 105. The native application 114 or the browser application 112 receives the notification and presents a message on a user interface of the application that the request received by the request processing unit 122 could not be processed. The user interface provides information indicating why the blocked content notification was issued in some implementations. The user may attempt to refine a natural language prompt to remove the potentially offensive content. A technical benefit of this approach is that the moderation services provides safeguards against both user-created and model-created content to ensure that prohibited offensive or potentially offensive content is not presented to the user in the native application 114 or the browser application 112.

FIG. 4 is a diagram showing additional features of the prompt construction unit 124 of the application services platform shown in FIG. 1. The prompt construction unit 124 includes a content retrieval unit 402, and a format converting unit 404. The prompt construction unit 124 provides user information identifying the user for which user data 136a is to be obtained from the user database 136. The user database 136 may include one or more sources of sample content authored by users of the application services platform 110. In some implementations, the user database 136 includes email messages and/or other types of messages, various types of electronic documents, electronic publications, and/or other sources of sample content that has been created by users. The electronic documents are associated with metadata in some implementations that indicates which users authored the electronic documents and/or which users authored specific portions of the electronic documents for electronic documents which had multiple users contribute to the document. The user database 136 can be implemented on the application services platform 110 in some implementations. In other implementations, at least a portion of the user database 136 are implemented on an external server that is accessible by the content retrieval unit 402 of the prompt construction unit 124.

The application services platform 110 complies with privacy guidelines and regulations that apply to the usage of the user data 136a included in the user database 136 to ensure that that users have control over how the application services platform 110 utilizes their data. The user is provided with an opportunity to opt into the application services platform 110 being able to access the user data 136a to enable the selected generative model 126b to generate content according to user preferred style(s)/format(s). In some implementations, the first time that an application, such as the native application 114 or the browser application 112 presents the data analysis assistant to the user, the user is presented with a message that indicates that the user may opt into allowing the application services platform 110 to access user data included in the user database 136 to support the data analysis assistant functionality. The user may opt into allowing the application services platform 110 to access all or a subset of user data included in the user database 136. Furthermore, the user may modify their opt-in status at any time by accessing their user data and selectively opting into or opting out of allowing the application services platform 110 from accessing and utilizing user data from the user database 136 as a whole or individually.

The content retrieval unit 402 is configured to formulate a query to the user database 136 based on the user ID and to provide any content items retrieved to the format converting unit 404. As mentioned, the user data 136a can be converted to a format directly processible by the selected generative model 126b.

By analogy, the content retrieval unit 402 is also configured to formulate a query to the expert knowledge database 134 and/or the selected calculation tool 132a, based on the statistical test and to provide any content items retrieved to the format converting unit 404. As mentioned in the description of FIG. 3, the expert knowledge data 134a and the calculation tool output can be converted to a format directly processible by the selected generative model 126b.

For instance, the content retrieval unit 402 is configured to utilize the Microsoft Graph® platform or other similar platforms to access a graph associated with the user. The Microsoft Graph® platform provides an application programming interface (API) that enables the content retrieval unit 402 to query the data included in the graph associated with the user. The graph includes content associated with various cloud-based services that has been authored by and/or modified by the user, such as but not limited to Microsoft Word®, Microsoft Teams®, Microsoft OneDrive®, Microsoft Outlook®, and/or other cloud-based services. The graph may include enterprise-specific information associated with the user, projects associated with the enterprise, project teams within the enterprise, and/or the technologies implemented by the enterprise, such as enterprise-specific terminology, acronyms, project names, and/or other terminology that may be utilized in the content items authored by the user. A technical benefit of this approach is that the selected generative model 126b is able to mimic the enterprise-specific terminology utilized by the user in the content generated by the selected generative model 126b in addition to the presentation style(s)/format(s) preferred by the user.

The content retrieval unit 402 is configured to perform a “graph walk” of the graph associated with the user to identify presentation style(s)/format(s) that have been authored by the user. The content retrieval unit 402 utilizes the Microsoft Graph® platform to obtain information from some user-related and/or user-generated content sources (e.g., emails, blogs, social media post, and the like.), while the content retrieval unit 402 utilizes other techniques to query other data sources which are not supported by the Microsoft Graph® platform in some implementations.

The presentation style/format of a user may change over time, so more recent content items are preferred for providing the selected generative model 126b with examples of the presentation style/format of the user. Furthermore, longer content items provide more context for the user. In some implementations, the content retrieval unit 402 applies an equal weight to recency and length of the content items when ranking the content items. In other implementations, the content retrieval unit 402 applies a greater weight to the recency of the content items than to the length of the sample content items. In yet other implementations, the content retrieval unit 402 applies a greater weight to the length of the content items than to the recency of the content items.

The content retrieval unit 402 is configured to select a predetermined number of content items to be included in the user content samples that will be included in the system prompt to be sent to the selected generative model 126b. If the number of sample content items is less that this predetermined number, then the content retrieval unit 402 includes all of the sample content items. The number of sample content items selected may be determined at least in part on the prompt size limits of the selected generative model 126b. As mentioned, language models typically have a limit on the number of tokens that can be included in the prompt, which will limit the number of user content samples, the previously discussed test result items. And other items that can be included in the system prompt. The selected sample content items can be input to the format converting unit 404 to be formatted into a format directly processible by the selected generative model 126b.

Referring back to FIG. 3, the prompt formatting unit 302 can incorporate the formatted sample content items output by the format converting unit 404 into the output of the prompt formatting unit 302 as the system prompt to be sent by the prompt submission unit 304 to the selected generative model 126b. The selected generative model 126b can analyze the test results to provide test result analysis output. The selected generative model 126b can also analyze the user content samples to determine a preferred presentation style/format for the test results. The selected generative model 126b can then provide the test result analysis output in a preferred presentation style/format for the user.

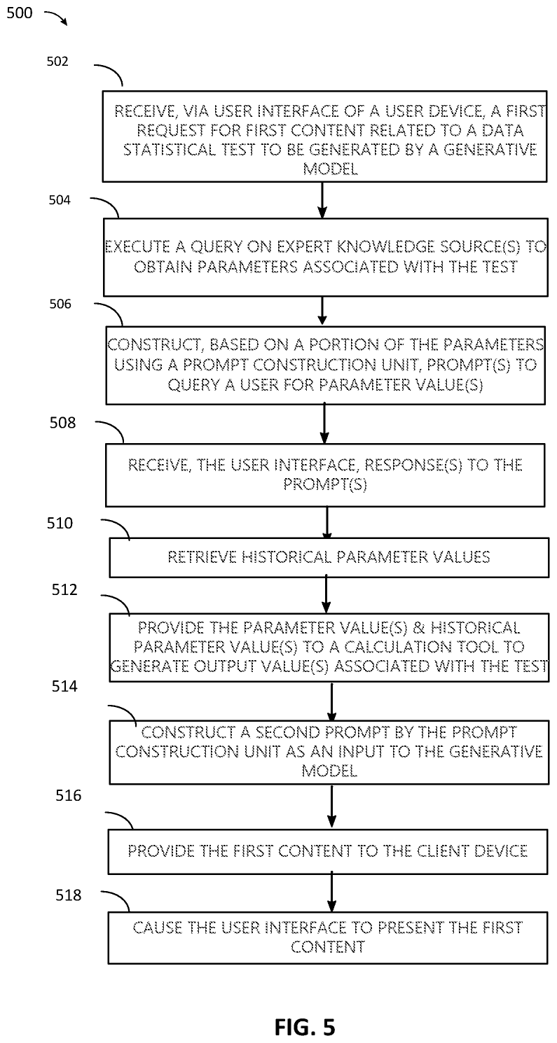

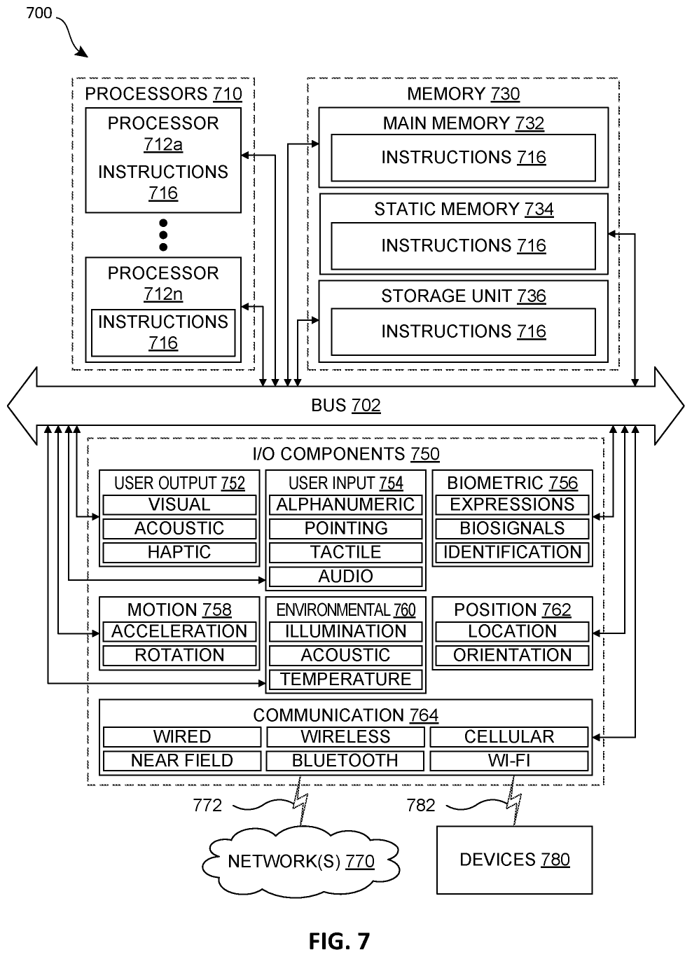

FIG. 5 is a flow chart of an example process 500 for a user to interact with a generative AI model to generate fast and accurate statistical analysis outputs on demand according to the techniques disclosed herein. The process 500 can be implemented by the application services platform 110 or its components shown in the preceding examples. The process 500 may be implemented in, for instance, the example machine including a processor and a memory as shown in FIG. 7. As such, the application services platform 110 can provide means for accomplishing various parts of the process 500, as well as means for accomplishing embodiments of other processes described herein in conjunction with other components of the example computing environment 100. Although the process 500 is illustrated and described as a sequence of steps, it is contemplated that various embodiments of the process 500 may be performed in any order or combination and need not include all the illustrated steps.

In one embodiment, for example, in step 502, the request processing module 122 can receive, via (e.g., a statistical analysis assistant application) a user interface of a client device (e.g., the client device 105) of a user, a first request (e.g., run the z-score test for last 4 weeks of data excluding load duration over 10 minutes) for first content (e.g., a statistical test result interpretation/summary) to be generated by a generative model (e.g., the general generative model 126a, the selected generative model 126b, etc.), the first request including a first prompt (e.g., “Can you run a Z-score test for last 4 weeks of data excluding load duration over 10 minutes?”) describing the first content to be generated, the first content being associated with one or more output values of a statistical test (e.g., a z-score test, a Mann-Kendall test, etc.).

The first application can be implemented by the native application 114 in some implementations. In other implementations, the first application is the browser application 112, and the user accesses a web application from the application services platform 110 using the browser application 112. As discussed in the preceding examples, the first user may input the natural language prompt in the prompt field of a user interface such as the user interface 205 shown in FIGS. 2A-2B.

For instance, the statistical test is a statistical anomaly detection test (e.g., a z-score test). As another example, the statistical test can be associated with an incident management system (e.g., a Mann-Kendall test).

In one embodiment, the prompt construction unit 124 can select the generative model among a plurality of generative models based on the statistical test. Beside the specific field of research and the availability of pre-trained models, the appropriate generative model for the statistical test can also depends on factors, such as the type of data to work with (e.g., text, images, numerical data, time series data, and more), size and computational resources, model performance (e.g., model accuracy, diversity of generated samples, and how well capturing the underlying data distribution, etc.), model interpretability, computational requirements and scalability, etc. Some popular generative models used in data analysis include generative adversarial networks (GANs), variational autoencoders (VAEs), flow models, diffusion models, etc.

In step 504, the prompt construction unit 124 executes a query on one or more expert knowledge sources to obtain parameters (e.g., sample mean, population mean under the null hypothesis, population standard deviation, sample size, etc.) associated with the statistical test (e.g., a z-score test), the parameters including one or more input parameters, one or more output parameters, or a combination thereof.

In step 506, the prompt construction unit 124 constructs, based on at least a portion of the parameters using a prompt construction unit (e.g., the prompt construction unit 124), one or more prompts (e.g., “How much is the significance threshold %?”) to query the user for one or more parameter values associated with the parameters. In step 508, the request processing module 122 receives, via the user interface, one or more responses (e.g., “The significance threshold is 5%”) to the one or more prompts, the one or more responses including the one or more parameter values.

In step 510, the prompt construction unit 124 retrieves historical data (e.g., incident data 140 in the enterprise data storage 138) including historical parameter values of the parameters (e.g., the daily average performance data of “Performance” as shown in Table 1), historical data records requested by the user, or a combination thereof associated with the statistical test.

In step 512, the prompt construction unit 124 provides the one or more parameter values and the historical data to a calculation tool (e.g., the statistical analysis tool 132a) to generate one or more output values associated with the statistical test. In one embodiment, the prompt construction unit 124 can select the calculation tool among a plurality of calculation tools based on the statistical test (e.g., the z-score test). Beside the nature of the data analysis and the specific calculations required, the appropriate calculation tool for the statistical test can also depend on factors such as open sources or commercial tools, software compatibility and integration, performance, data security and privacy, user familiarity/preferences, etc.

In another embodiment, the prompt construction unit 124 executes another query on the one or more expert knowledge sources to obtain one or more assumed parameter values associated with the parameters, and provides the one or more assumed parameter values with the one or more parameter values (e.g., assuming 80% power and 5% significance if not specified for a A/B test) to the calculation tool to generate the one or more output values.

In step 514, the prompt construction unit 124 constructs a second prompt by the prompt construction unit as an input to the generative model, the prompt construction unit constructing the second prompt by appending at least the one or more prompts (e.g., the user prompts, the meta-prompts, the system prompts, etc.) and the one or more responses (e.g., the calculation toll output data) with an instruction string, the instruction string comprising instructions to the generative model to generate an interpretation (e.g., the last Assistant prompt in FIG. 2B) of the one or more output values as the first content.

In step 516, the request processing module 122 provides the first content (e.g., a statistical test result interpretation/summary) to the client device (e.g., the client device 105). In step 518, the request processing module 122 causes the user interface to present the first content (e.g., FIG. 2B).

The prompt construction unit 124 determines a preferred output format for the user based on user data associated with the user. The second prompt can be constructed by appending the user data to the one or more prompts, the one or more responses, and the instruction string, and the instruction string can comprise instructions to the generative model to determine a preferred output format for the user based on the user data and to present the interpretation in the preferred output format as the first content.

The prompt construction unit 124 generates summaries of data in the one or more expert knowledge sources by inputting the data to the generative model, the summaries including output parameters metrics definitions, technical specifications, data on how to analyze outputs of the calculation tool, or a combination thereof associated with the statistical test. For instance, the query executed on the one or more expert knowledge sources can be executed on the summaries instead.

In one embodiment, the prompt construction unit 124 can generate a prompt to infer, via the generative model, one or more actions to take to cope with the interpretation, and then cause the user interface to present the interpretation with the one or more actions.

In one embodiment, the example computing environment 100 can encrypt communication between the data processing system, the client device, and an enterprise system of the enterprise using a cryptographic protocol, and isolates enterprise data by keeping containers, storages, or a combination thereof at least logically or physically separate from other enterprises.

A technical benefit of this approach is that the test result analysis presentation better reflects the presentation style/format preferred by the user than the generic or default presentation style/format generated by a generative model, such as the selected generative model 126b. The prompt construction unit 124 analyzes the prompt, which includes the natural language prompt provided by the user and the parameter value(s) associated with the statistical test, to generate the recommend data analysist test in the natural language prompt. After completing the test, the prompt construction unit 124 generates another prompt based on the test results and user data to provide to the selected generative model 126b. The selected generative model 126b analyzes the test results, determines a preferred presentation style/format based on user data, and then causes the application of the user device to present the test result analysis/summary on the user interface based on the presentation style/format preferred by the user.

Therefore, the system can assist users to apply expert knowledge (e.g., past examples, similar scenarios, guidelines, etc.) and insights from historical data to support data-driven decision-making (e.g., whether an incident alert needs to be mitigated), via a chat interface.

Such interactive, chat-based expert guidance and statistical analysis assistance can help a user to set up and execute experimentation/tests quickly and accurately with scientific rigor. In addition, the system provides users interactive tools to refine the set up, and interpret results of a completed experiment/test through generative AI models.

The detailed examples of systems, devices, and techniques described in connection with FIGS. 1-5 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-5 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

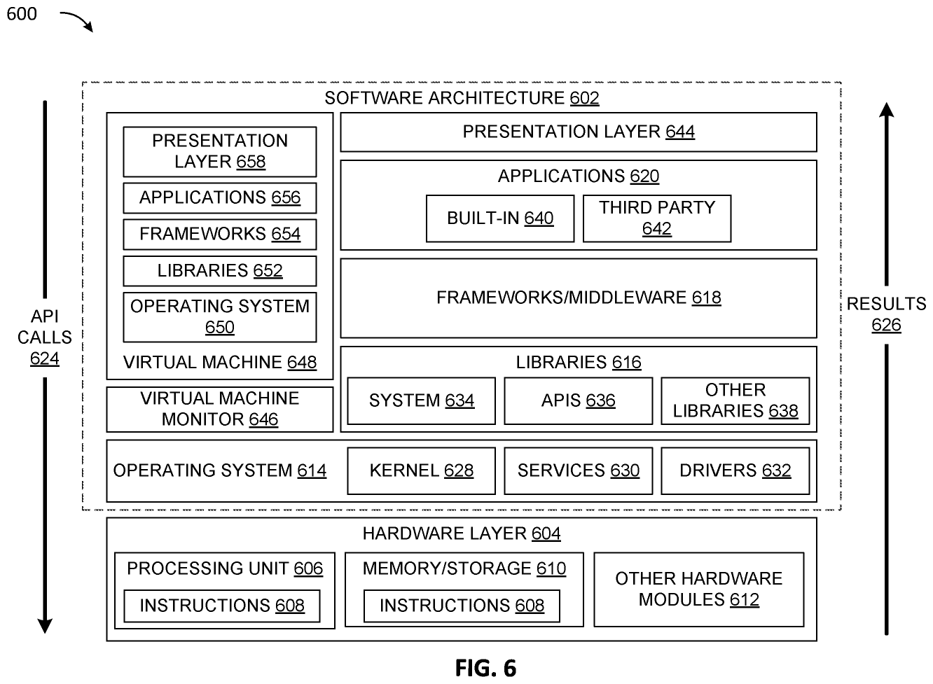

FIG. 6 is a block diagram 600 illustrating an example software architecture 602, various portions of which may be used in conjunction with various hardware architectures herein described, which may implement any of the above-described features. FIG. 6 is a non-limiting example of a software architecture, and it will be appreciated that many other architectures may be implemented to facilitate the functionality described herein. The software architecture 602 may execute on hardware such as a machine 700 of FIG. 7 that includes, among other things, processors 710, memory 730, and input/output (I/O) components 750. A representative hardware layer 604 is illustrated and can represent, for example, the machine 700 of FIG. 7. The representative hardware layer 604 includes a processing unit 606 and associated executable instructions 608. The executable instructions 608 represent executable instructions of the software architecture 602, including implementation of the methods, modules and so forth described herein. The hardware layer 604 also includes a memory/storage 610, which also includes the executable instructions 608 and accompanying data. The hardware layer 604 may also include other hardware modules 612. Instructions 608 held by processing unit 606 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks 618, applications 620, and a presentation layer 644. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks 618 (also sometimes referred to as middleware) provide a higher-level common infrastructure that may be used by the applications 620 and/or other software modules. For example, the frameworks 618 may provide various graphic user interface (GUI) functions, high-level resource management, or high-level location services. The frameworks 618 may provide a broad spectrum of other APIs for applications 620 and/or other software modules.

The applications 620 include built-in applications 640 and/or third-party applications 642. Examples of built-in applications 640 may include, but are not limited to, a contacts application, a browser application, a location application, a media application, a messaging application, and/or a game application. Third-party applications 642 may include any applications developed by an entity other than the vendor of the particular platform. The applications 620 may use functions available via OS 614, libraries 616, frameworks 618, and presentation layer 644 to create user interfaces to interact with users.

Some software architectures use virtual machines, as illustrated by a virtual machine 648. The virtual machine 648 provides an execution environment where applications/modules can execute as if they were executing on a hardware machine (such as the machine 700 of FIG. 7, for example). The virtual machine 648 may be hosted by a host OS (for example, OS 614) or hypervisor, and may have a virtual machine monitor 646 which manages operation of the virtual machine 648 and interoperation with the host operating system. A software architecture, which may be different from software architecture 602 outside of the virtual machine, executes within the virtual machine 648 such as an OS 650, libraries 652, frameworks 654, applications 656, and/or a presentation layer 658.

FIG. 7 is a block diagram illustrating components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement modules or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multi-core processor including cores that may execute instructions contemporaneously. Although FIG. 7 shows multiple processors, the machine 700 may include a single processor with a single core, a single processor with multiple cores (for example, a multi-core processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756, motion components 758, environmental components 760, and/or position components 762, among a wide array of other physical sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 758 may include, for example, acceleration sensors (for example, an accelerometer) and rotation sensors (for example, a gyroscope). The environmental components 760 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 762 may include, for example, location sensors (for example, a Global Position System (GPS) receiver), altitude sensors (for example, an air pressure sensor from which altitude may be derived), and/or orientation sensors (for example, magnetometers).

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 764 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 764, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a machine-readable storage medium storing executable instructions that, when executed, cause the processor alone or in combination with other processors to perform operations of:
receiving, via a user interface of a client device of a user, a first request for first content to be generated by a generative model, the first request including a first prompt describing the first content to be generated, the first content being associated with one or more output values of a statistical test;
executing a query on one or more expert knowledge sources to obtain parameters associated with the statistical test, the parameters including one or more input parameters, one or more output parameters, or a combination thereof;
constructing, based on at least a portion of the parameters using a prompt construction unit, one or more prompts to query the user for one or more parameter values associated with the parameters;
receiving, via the user interface, one or more responses to the one or more prompts, the one or more responses including the one or more parameter values;
retrieving historical data including historical parameter values of the parameters, historical data records requested by the user, or a combination thereof associated with the statistical test;
providing the one or more parameter values and the historical data to a calculation tool to generate one or more output values associated with the statistical test;
constructing a second prompt by the prompt construction unit as an input to the generative model, the prompt construction unit constructing the second prompt by appending at least the one or more prompts and the one or more responses with an instruction string, the instruction string comprising instructions to the generative model to generate an interpretation of the one or more output values as the first content;
providing the first content to the client device; and
causing the user interface to present the first content.

2. The data processing system of claim 1, wherein the machine-readable storage medium further includes instructions configured to cause the processor alone or in combination with other processors to perform operations of:
selecting the calculation tool among a plurality of calculation tools based on the statistical test.

3. The data processing system of claim 1, wherein the machine-readable storage medium further includes instructions configured to cause the processor alone or in combination with other processors to perform operations of:
selecting the generative model among a plurality of generative models based on the statistical test.

4. The data processing system of claim 1, wherein the machine-readable storage medium further includes instructions configured to cause the processor alone or in combination with other processors to perform operations of:
executing another query on the one or more expert knowledge sources to obtain one or more assumed parameter values associated with the parameters; and
providing the one or more assumed parameter values with the one or more parameter values to the calculation tool to generate the one or more output values.

5. The data processing system of claim 1, wherein the machine-readable storage medium further includes instructions configured to cause the processor alone or in combination with other processors to perform operations of:
determining a preferred output format for the user based on user data associated with the user,
wherein constructing the second prompt comprises appending the user data to the one or more prompts, the one or more responses, and the instruction string, and the instruction string comprises instructions to the generative model to determine a preferred output format for the user based on the user data and to present the interpretation in the preferred output format as the first content.

6. The data processing system of claim 1, wherein the machine-readable storage medium further includes instructions configured to cause the processor alone or in combination with other processors to perform operations of:
generating summaries of data in the one or more expert knowledge sources by inputting the data to the generative model, the summaries including output evaluation criteria metrics definitions, technical specifications, data on how to analyse outputs of the calculation tool, or a combination thereof associated with the statistical test,
wherein executing the query on the one or more expert knowledge sources includes executing the query on the summaries.

7. The data processing system of claim 1, wherein the user belongs to an enterprise, and the machine-readable storage medium further includes instructions configured to cause the processor alone or in combination with other processors to perform operations of:
inferring, via the generative model, one or more actions to take to cope with the interpretation; and
causing the user interface to present the interpretation with the one or more actions.

8. The data processing system of claim 1, wherein the user belongs to an enterprise, and the machine-readable storage medium further includes instructions configured to cause the processor alone or in combination with other processors to perform operations of:
encrypting communication between the data processing system, the client device, and an enterprise system of the enterprise using a cryptographic protocol; and
isolating enterprise data by keeping containers, storages, or a combination thereof at least logically or physically separate from other enterprises.

9. The data processing system of claim 1, wherein the statistical test is a statistical anomaly detection test.

10. The data processing system of claim 1, wherein the statistical test is associated with an incident management system.

11. A method comprising:
receiving, via a user interface of a client device of a user, a first request for first content to be generated by a generative model, the first request including a first prompt describing the first content to be generated, the first content being associated with one or more output values of a statistical test;
executing a query on one or more expert knowledge sources to obtain parameters associated with the statistical test, the parameters including one or more input parameters, one or more output parameters, or a combination thereof;
constructing, based on at least a portion of the parameters using a prompt construction unit, one or more prompts to query the user for one or more parameter values associated with the parameters;
receiving, via the user interface, one or more responses to the one or more prompts, the one or more responses including the one or more parameter values;
retrieving historical data including historical parameter values of the parameters, historical data records requested by the user, or a combination thereof associated with the statistical test;
providing the one or more parameter values and the historical data to a calculation tool to generate one or more output values associated with the statistical test;
constructing a second prompt by the prompt construction unit as an input to the generative model, the prompt construction unit constructing the second prompt by appending at least the one or more prompts and the one or more responses with an instruction string, the instruction string comprising instructions to the generative model to generate an interpretation of the one or more output values as the first content;
providing the first content to the client device; and
causing the user interface to present the first content.

12. The method of claim 11, further comprising:
selecting the calculation tool among a plurality of calculation tools based on the statistical test.

13. The method of claim 11, further comprising:
selecting the generative model among a plurality of generative models based on the statistical test.

14. The method of claim 11, further comprising:
executing another query on the one or more expert knowledge sources to obtain one or more assumed parameter values associated with the parameters; and
providing the one or more assumed parameter values with the one or more parameter values to the calculation tool to generate the one or more output values.

15. The method of claim 11, further comprising:
determining a preferred output format for the user based on user data associated with the user,
wherein constructing the second prompt comprises appending the user data to the one or more prompts, the one or more responses, and the instruction string, and the instruction string comprises instructions to the generative model to determine a preferred output format for the user based on the user data and to present the interpretation in the preferred output format as the first content.

16. A non-transitory computer readable medium on which are stored instructions that, when executed, cause a programmable device to perform functions of:
receiving, via a user interface of a client device of a user, a first request for first content to be generated by a generative model, the first request including a first prompt describing the first content to be generated, the first content being associated with one or more output values of a statistical test;
executing a query on one or more expert knowledge sources to obtain parameters associated with the statistical test, the parameters including one or more input parameters, one or more output parameters, or a combination thereof;
constructing, based on at least a portion of the parameters using a prompt construction unit, one or more prompts to query the user for one or more parameter values associated with the parameters;
receiving, via the user interface, one or more responses to the one or more prompts, the one or more responses including the one or more parameter values;
retrieving historical data including historical parameter values of the parameters, historical data records requested by the user, or a combination thereof associated with the statistical test;
providing the one or more parameter values and the historical data to a calculation tool to generate one or more output values associated with the statistical test;
constructing a second prompt by the prompt construction unit as an input to the generative model, the prompt construction unit constructing the second prompt by appending at least the one or more prompts and the one or more responses with an instruction string, the instruction string comprising instructions to the generative model to generate an interpretation of the one or more output values as the first content;
providing the first content to the client device; and
causing the user interface to present the first content.

17. The non-transitory computer readable medium of claim 16, wherein the instructions when executed, further cause the programmable device to perform functions of selecting the calculation tool among a plurality of calculation tools based on the statistical test.

18. The non-transitory computer readable medium of claim 16, wherein the instructions when executed, further cause the programmable device to perform functions of selecting the generative model among a plurality of generative models based on the statistical test.

19. The non-transitory computer readable medium of claim 16, wherein the instructions when executed, further cause the programmable device to perform functions of:
executing another query on the one or more expert knowledge sources to obtain one or more assumed parameter values associated with the parameters; and
providing the one or more assumed parameter values with the one or more parameter values to the calculation tool to generate the one or more output values.

20. The non-transitory computer readable medium of claim 16, wherein the instructions when executed, further cause the programmable device to perform functions of:
determining a preferred output format for the user based on user data associated with the user,
wherein constructing the second prompt comprises appending the user data to the one or more prompts, the one or more responses, and the instruction string, and the instruction string comprises instructions to the generative model to determine a preferred output format for the user based on the user data and to present the interpretation in the preferred output format as the first content.
